(19) United States
(12) Patent Application Publication
(10) Pub. No.: US 2010/0027981 A1
(43) Pub. Date: Feb. 4, 2010

(54) Infant formula maker and brewer

(76) Inventor: Deborah Callantine, Rocklin, CA (US)

Correspondence Address: MATHEW J. TEMMERMAN, 423 E STREET, DAVIS, CA, 95616, US

(21) Appl. No.: 12/334,467

(22) Filed: Dec. 14, 2008

Related U.S. Application Data
(60) Provisional application No. 61/085,655, filed on Aug. 1, 2008.

(51) Int. Cl. A47J 31/54; F24H 1/20

(52) U.S. Cl. 392/442; 392/451

(57) ABSTRACT

The present invention is a warmer for heating liquids for use with powdered infant formula. In an exemplary embodiment the device comprises a water reservoir and pump, heating element, and carafe demarcated in ounces to allow the user to easily add the appropriate amount of infant formula after the water is warmed. In use, up to 64 ounces of water is placed in the water reservoir. The reservoir warms the water to the optimum temperature and fills the carafe through a water outlet. The carafe rests on a platform that is not heated so as to not bring the temperature above the optimum temperature for making formula. As further described herein, the system ensures a smooth and silky mixed formula of the proper concentrations.

### RELATED APPLICATIONS

This application is related to and claims priority from provisional patent application Ser. No. 61/085,655, filed Aug. 1, 2008. This application is related to but does not claim priority from previously filed U.S. design patent application Ser. No. 29/321,699, filed Jul. 22, 2008.

### BACKGROUND

1. Field of the Invention

The present invention is related to infant formula warmers, and more specifically to drip-based electrically controlled infant formula warmers. In an exemplary embodiment the device comprises a water reservoir and pump, heating element, and carafe demarcated in ounces to allow the user to easily add the appropriate amount of infant formula once the water has been warmed.

2. Background of the Invention

Infant formula is a nutritionally adequate and safe complementary food for infants and a suitable human breast milk substitute. It is typically made from altered cow's milk formula, soy-based components or a protein hydrolysate base. The success of the first commercially available infant formula, Liebig's Soluble Food for Babies, dating to 1867 led quickly to advancements being made both in the formulation itself and the means for warming it and ensuring a smooth mixture.

By the 1920s, evaporated milk began to be commercially available at low prices and in fact by the 1950s over half of all infants in the United States were fed such compositions. Although evaporated milk became very popular by the 1950s, by the early 1960s infant formula had replaced it and was sold in greater numbers than evaporated milk formulas. By the 1970s, over three quarters of infants in the United States were reared at least partially on infant formula, most of which was commercially manufactured. Today, infant formula is the only other infant milk substitute that the medical community considers nutritionally acceptable for infants under the age of one year. There is thus a large market and need for advancements and ease of use for such a commonly used item.

Although whether to use infant formula is almost always a choice made by the baby's mother, there are several cases where use of infant formula is recommended over a mother's milk. For instance, if the mother has certain infectious diseases, is malnourished, has had certain kinds of breast surgery, or takes medication that could be harmful to the infant, it may be recommended to use formula instead. Other scenarios that may force the use of infant formula are infant birth defects such as a metabolic disorder affecting the infant's capability to properly metabolize the sugar galactose, or even the unavailability of the mother to breast-feed. Although these cases may require the use of infant formula, in the vast majority of cases it is simply the decision of the mother not to breast-feed. There is thus a large need for preparing infant formula for those who choose to use it and more importantly, for those who need to use it.

Infant formula is commercially available in several forms, including ready-to-feed, liquid concentrate and powder. Ready-to-feed and liquid concentrate formula is generally more expensive than powdered formula, and hence powdered formula has become quite popular. In return, these types of formula are generally easier for the caregiver to prepare. Many commercially available powdered formula products recommend mixing the powder with warm (but not hot) water for a smoother blend.

In addition to temperature, when mixing powder there is a chance the formula prepared could be overdiluted or underdiluted. If the formula is too diluted or too concentrated, the infant's electrolyte balance may be upset, preventing the infant's nutritional needs from being met. Typical instructions for preparing formula require a certain amount of powdered formula per liquid ounce of water.

There is thus a need for a device to assist in the preparation of baby formula in the proper concentrations and using warm, but not hot water. There is a further need for this device to be simple and all in one, that is, provide water at the required temperature and be delineated in liquid ounces to ensure the concentration of the mixture is optimum.

3. Description of Related Art

There are numerous applications for heating fluids and heating baby formula, as detailed below.

U.S. Pat. No. 4,331,067 to Mysicka et al., describes a coffeemaker adapted to supply heated water and comprising a basket adapted to hold coffee grounds and to receive heater water from the source, so as to yield an infusion from the grounds as infused by heated water from the source. This patent is exemplary of the fact that coffeemakers are well known. No prior art as been found wherein a coffeemaker has been adapted into an infant formula warmer. Furthermore, the device is more complicated than is necessary for such a device.

U.S. Pat. No. 3,908,530 to Simon and Rakocy, describes a coffeemaker wherein the temperature of the water brew is between 185° F. and 205° F. The holding temperature of the hot plate after the coffee has been made is between 185° F. and 189° F. for at least one half hour after preparation of the beverage. This is far too hot for infant formula, but does show that while temperature considerations have been made, however, they are at least in the '530 patent, too hot for use with infants and infant powdered formula. Furthermore, the hot plate in use on the device not only adds to the complexity and cost of the device, but may in addition heat the mixture to a suboptimal temperature.

U.S. Pat. No. 6,951,166 to Sickels, describes a unit for preparing baby formula. The unit heats water to a specified temperature and then alerts a user or automatically mixes the heated water with dry baby formula and dispenses the mixture into a baby bottle. This device is somewhat complicated and would likely be too expensive for common usage.

Zojirushi manufactures and sells a “Zojirushi Hot Water Dispenser, 4.0L” that comprises a reservoir wherein water is heated to either 175° F., 195° F. or 205° F. It is then dispensed out an outlet on the front of the unit. The unit merely heats hot water and does not comprise any means for providing measurement information to the user with relation to infant formula. Furthermore, the device heats the water beyond that would be desirable for mixing infant formula.

West Bend sells a “West Bend 56204 Single-Cup Coffee and Water Dispenser” that quickly heats and dispenses up to 12 ounces of liquid. It is stated for use with coffee, tea, hot chocolate, and instant soup. Again, this unit heats hot water and does not comprise any means for providing measurement information to the user with relation to infant formula. Furthermore, the device heats the water above a temperature that would be desirable for mixing infant formula.

It is thus an object of the present invention to create an aesthetically pleasing warmer for water for infant formula that is both simple to use and simple to construct. It is a further object of the invention to provide a device that in 10 minutes creates formula with the same smoothness and consistency of ready-made formula. Finally, it is an object of the present invention to provide a less time consuming means for a consumer to prepare infant formula from a powdered mixture.

### SUMMARY OF THE INVENTION

The present invention is a warmer for heating liquids for use with powdered infant formula. In an exemplary embodiment the device comprises a water reservoir and pump, heating element, and carafe demarcated in ounces to allow the user to easily add the appropriate amount of infant formula. In use, up to 64 ounces of water is placed in the water reservoir. The reservoir warms the water to the optimum temperature and fills the carafe through a water outlet. The carafe rests on a platform that is not heated so as to not bring the temperature above the optimum temperature for making formula. As further described herein, the system ensures a smooth and silky mixed formula of the proper concentrations.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is a left perspective view of the infant baby formula maker and brewer according to a preferred embodiment of the invention, wherein a hinged lid is closed according to a first configuration;

FIG. 2 is a left side planar view of the infant baby formula maker and brewer according to a preferred embodiment of the invention, wherein the hinged lid is closed according to a first configuration;

FIG. 3 is a front side planar view of the infant baby formula maker and brewer according to a preferred embodiment of the invention, wherein the hinged lid is closed according to a first configuration;

FIG. 4 is a rear side planar view of the infant baby formula maker and brewer according to a preferred embodiment of the invention wherein the hinged lid is closed according to a first configuration;

FIG. 5 is a top side planar view of the infant baby formula maker and brewer according to a preferred embodiment of the invention wherein the hinged lid is closed according to a first configuration;

FIG. 6 is a top side planar view of the infant baby formula maker and brewer according to a preferred embodiment of the invention wherein the hinged lid is closed according to a first configuration;

FIG. 7 is a left side planar view of the infant baby formula maker and brewer according to a preferred embodiment of the invention wherein the hinged lid is in an open position on the heater; and

FIG. 8 is a front side planar view of the infant baby formula maker and brewer according to a preferred embodiment of the invention, wherein the hinged lid is in an open position on the heater.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

The present device is a warmer for the preparation of infant formula, the warmer comprising a water reservoir with heater, water outlet, and carafe. In use, up to 64 ounces of water is placed in the water reservoir. The reservoir warms the water to the optimum temperature and fills the carafe through a water outlet. The carafe rests on a platform that is not heated so as to not bring the temperature above the optimum temperature for making formula. As further described below, the system ensures a smooth and silky mixed formula of the proper concentrations.

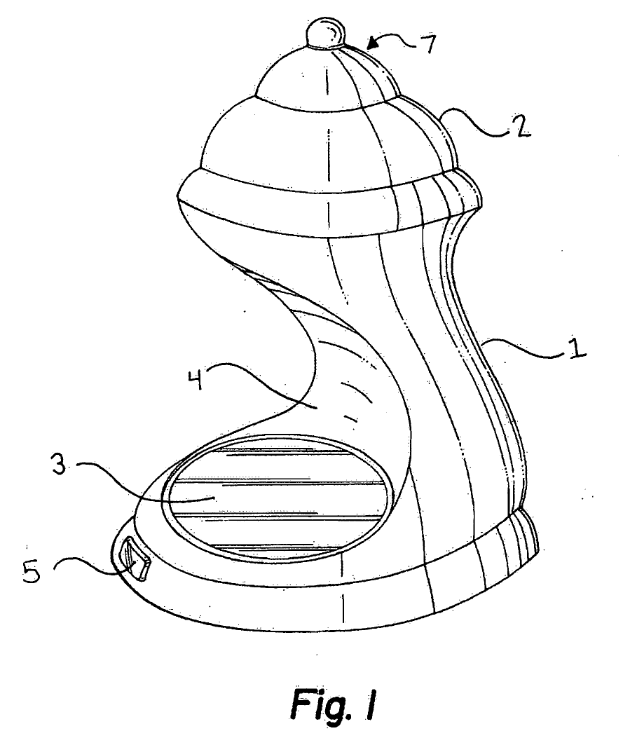

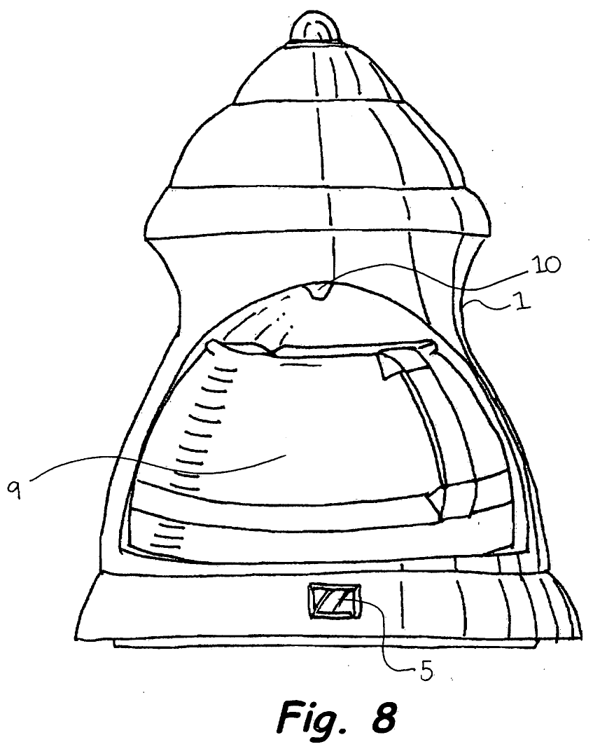

Turning first to FIG. 1, the present invention is shaped like a large baby bottle with the central portion 1 having a cutout 4 for the positioning of a carafe (see FIG. 8). Inside the cutout is a water outlet (see FIG. 8) as well as an unheated platform 3. The platform is unheated to ensure that the temperature of the mixture does not reach beyond optimum, and to prevent the mixture from staying too warm for too long a time, which increases the chance for bacteria growth. An on/off button 5 turns on and off the heather that warms water that has been poured into the internal reservoir. For purposes of succinctness the internal reservoir and heating system are not shown, due to their being well know in the art.

Continuing with FIG. 1, the device further has a rear-hinged top 2 with a decorative nipple 7 as a cap. The device is approximately 12 inches high, having a round top six inches in diameter and a round bottom eight inches in diameter. All measurements are approximate and the product dimensions may vary significantly without departing from the spirit of the invention. In a preferred embodiment, the device is partially transparent and is made from pieces having vibrant colors such as hot pink, robin egg blue, sun yellow, lime green and frosted white. Overall, the device is aesthetically pleasing to the eye and artistically styled after a baby's bottle.

Turning briefly to FIG. 8, a carafe 9 is shown in place on unheated platform 3 (not labeled in FIG. 8), complimenting the curved lines of the device and completed the artistic shape of the device as a large baby bottle. The carafe is made preferably of clear glass, although other materials may be used. The clear carafe allows the user to easily read the amount of liquid ounces of water in the carafe, by comparing the water level with the markings on the side of the carafe. Once the number of ounces is known, the user can easily pour in an appropriate amount of dry powdered formula, and stir. The carafe is dishwasher safe but may also be washed by hand.

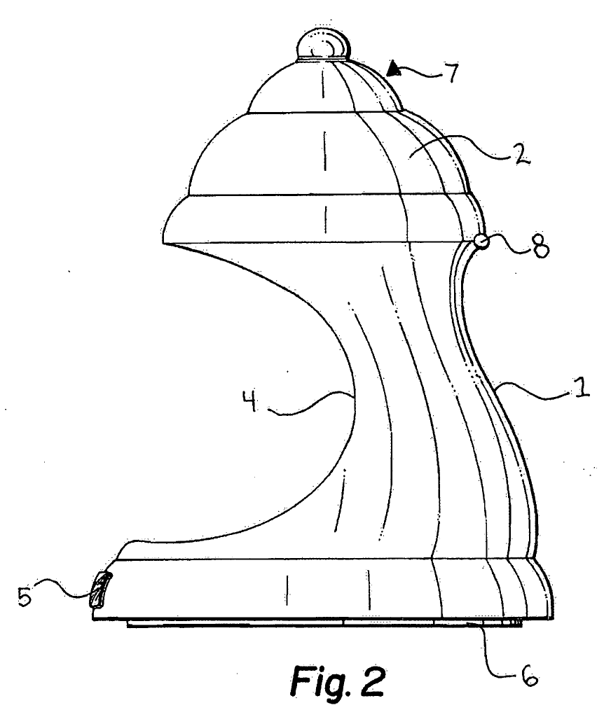

Turning now to FIG. 2, a side planar view of the device is depicted, wherein a hinge 8 for the top 2 of the device is shown. The top of the device flips open around an axis defined by the hinge, allowing the user to pour water into the device with ease. FIG. 2 also depicts base 6 for the device, which provides space between the rest of the device and area on which it rests. Base 6 may be made of a nonstick material engineered to reduce the ability of other materials to stick to it. Materials such as polytetrafluoroethylene (available by DuPont) or similar may be used for purposes of keeping the device in place, and may also serve to lessen the chance of any water on a counter reaching the device beyond base 6. Not shown in the figures for purposes of simplicity is an electrical power plug for providing power to the device.

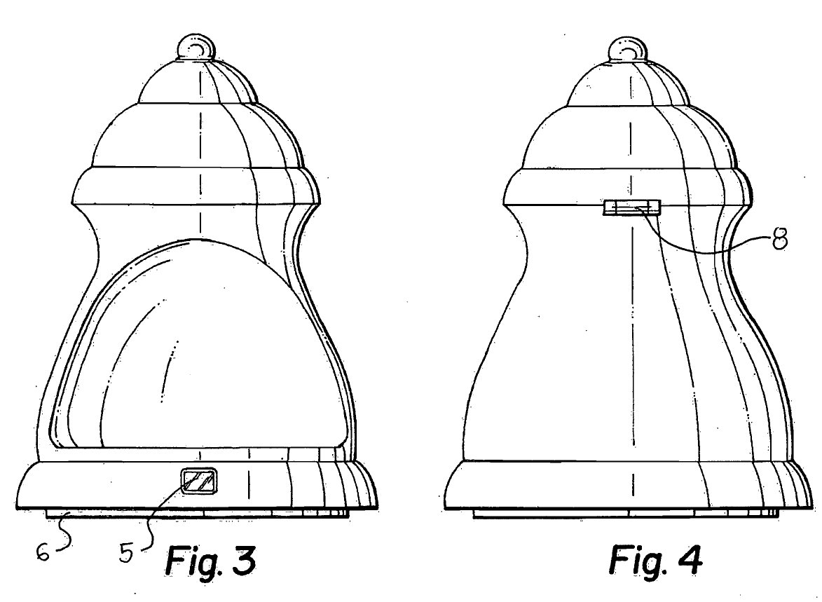

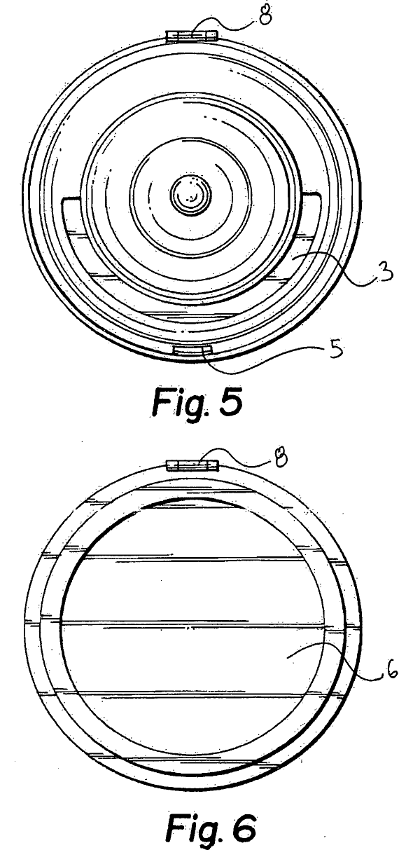

FIG. 3 is a front planar view of the device showing an opening that is matched to the shape of the carafe 9 shown in FIG. 8. FIG. 4 depicts the rear of the device and hinge 8. FIG. 6 depicts among other things base 6, and FIG. 5 gives a top view of the device including the unheated platform 3.

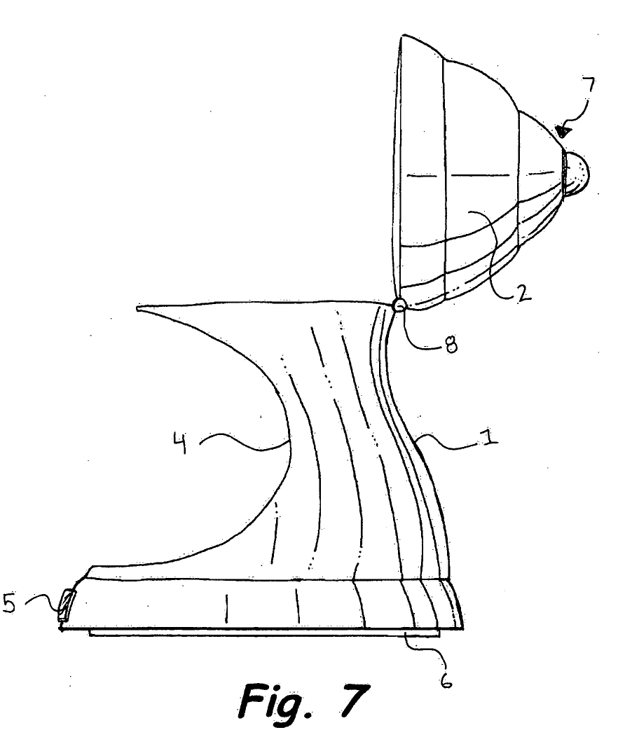

FIGS. 7 and 8 depict the device in a configuration wherein the top is open. Not shown, but inside the device is a reservoir for holding up to 64 liquid ounces of water. Once the water is inside the device, the user closes the lid and activates the heater by pressing button 5. In an alternative embodiments of the device, the device will not turn on unless the water is present, unless the lid is closed, or both. In one such embodiment, a pump actuator is biased to a closed position but may be moved to an open position when the carafe is in place. FIG. 8 depicts carafe 9 in place, as well as water outlet 10, which is connected via tubing to the internal reservoir. It is noted that the carafe is generally the same shape as the opening in which it rests, creating a substantially snug fitment and contributing the aesthetically pleasing nature of the design of the device.

The device itself is preferably made of a lightweight molded stainless steel; further comprising stainless steel tubing between the internal reservoir and the water outlet 10. In this preferred embodiment, plastics are not used due to the recent health hazards that have been discovered due to the potential leaching of chemicals from certain hard plastics into other materials that are to be ingested into the human body. For instance, the ubiquitous compound Bisphenol A (BPA), a key building block in many plastic bottles, has been found to leach from plastics and resins. Indeed, in a 2004 test, the U.S. Centers for Disease Control (CDC) discovered at least traces of BPA in nearly all urine samples collected. Although the levels at which it was discovered were below the level that is considered safe by the U.S. Environmental Protection Agency (EPA) and the European Union's European Food Safety Authority, and although not all plastics have been found to leach chemicals, such discoveries nevertheless cause concern among consumers and have prompted a resurgence of glass for use in bottles and food storage containers. In practice, rubber or plastic tubing may be used and indeed most of the external components may be made from plastics or other materials, but metal and glass is preferred in the exemplary embodiment.

In an alternative embodiment of the invention steps are taken to ensure sanitary conditions are maintained in the water reservoir. For instance, in an exemplary case the reservoir has a plug that may be used to drain any water remaining, as well as a timer or sensor for the heating element that ensures all liquids have evaporated from the reservoir before the heating element is deactivated.

In an additional alternative embodiment of the invention, an optional whisk is included to allow the user to blend the ingredients into an even smoother mixture by incorporating air into the mixing process. In yet an additional alternative embodiment of the invention, a rotary whisk comprising two sets of beaters joined together and rotating in opposite directions is employed, either as an optional external accessory or as an integral part of the warmer itself and attached to the top of the device as a portable mixer.

The simple on/off switch may in an alternative embodiment of the invention the device further comprise a temperature selection gauge that cooperates with the thermostat in the reservoir by regulating whether it is on or off. In this embodiment, the device warms the liquid in the reservoir no further then the temperature set on the temperature selection gauge.

Other accessories that may be included with the device are baby bottles 4 to 8 oz, nipples, nuks, sippy glasses, bottle brushes, baby bibs, mixer plug in ports, thermal storage bags, and storage pitchers for use in the refrigerator.

In use, one pours the desired amount of water in the top of the device, and turns the device on. The water, stored in a reservoir in the back of the device, will heat to a warm temperature until a pump moves the water from the well in the back of the device up into the top of the device, from which point it will drip down into the carafe. The user then pours the powdered formula into the carafe as directed on the formula directions. Finally, the user stirs the carafe for about one minute, sets it back on the unheated platform 3 until cooled, and then stores it in the refrigerator in either bottles or simply in the carafe itself. The device in an alternative embodiment remains heated until all water in the reservoir has evaporated, thereby ensuring sanitary conditions for next use.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A heater for water for infant formula comprising:
a. a housing;
b. an open-topped transparent container having a handle and delineated markings for assessing an amount of liquid in said container; and
c. a reservoir for warming water, said reservoir further comprising a pump and a heating element such that water placed in said reservoir is warmed by said heating element and then pumped by said pump into said open-topped container.

2. The heater for water for infant formula according to claim 1, wherein substantially all water is pumped by said pump into said open-topped container, and wherein said heating element turns off after said substantially all water is pumped.

3. The heater for water for infant formula according to claim 1 wherein said water is pumped through a stainless steel tube, and wherein said reservoir consists of stainless steel.

4. The heater for water for infant formula according to claim 3, wherein substantially all water is pumped by said pump into said open-topped container, and wherein said heating element turns off after said substantially all water is pumped.

5. The heater for water for infant formula according to claim 4 wherein said water is pumped through a stainless steel tube, and wherein said reservoir consists of stainless steel.

6. The heater for water for infant formula according to claim 5, wherein said housing further comprises an opening and wherein said open-topped transparent container is removably nested within said opening.

7. The heater for water for infant formula according to claim 6, wherein substantially all water is pumped by said pump into said open-topped container, and wherein said heating element turns off after said substantially all water is pumped.

8. A heater for water for infant formula comprising:
a. a housing comprising an opening;
b. a receptacle removably nesting within said opening, said receptacle marked measurement indicators for determining the volume of said receptacle in liquid ounces;
c. a water reservoir further comprising water, a heating element and an inflow tube; and
d. an outflow tube fluidly connected to said inflow tube, having an end positioned above said receptacle.

9. The heater for water for infant formula according to claim 8 wherein said receptacle is substantially transparent to permit visual observation of a composition therein.

10. The heater for water for infant formula according to claim 9 further comprising a thermostat and thermostat control panel that cooperates with said thermostat.

11. The heater for water for infant formula according to claim 8 further comprising a pump and wherein said water is pumped by said pump from said water reservoir to said end positioned above said receptacle, and wherein water falls from said end into said receptacle.

12. The heater for water for infant formula according to claim 11, wherein substantially all water is pumped by said pump into said receptacle, and wherein said heating element is on before substantially all water is pumped and off after substantially all water is pumped.

13. The heater for water for infant formula according to claim 12 further comprising a thermostat and thermostat control panel that cooperates with said thermostat.

14. The heater for water for infant formula according to claim 13 wherein said receptacle is substantially transparent to permit visual observation of a composition therein.

15. The combined infant formula warmer according to claim 14 wherein a pump actuator is connected to said pump, the actuator biased to a closed position but which may be moved to an open position when said receptacle is nested within said opening.

16. An apparatus for preparing infant formula, the apparatus comprising:
a. a water reservoir;
b. means for heating water within said water reservoir;
c. a substantially transparent receptacle for catching liquid emerging from said water reservoir, a wall of the receptacle being provided with an optical means for indicating the volume of liquid contained in the receptacle in fluid ounces; and
d. an opening sized such that said receptacle may nest within.

17. The apparatus for preparing infant formula according to claim 16 further comprising a thermostat and thermostat control panel that cooperates with said thermostat.

18. The apparatus for preparing infant formula according to claim 17 further comprising:
a. a pump for pumping said liquid from said water reservoir to said receptacle;
b. a heater for warming said liquid; and
c. wherein substantially all liquid is pumped by said pump into said receptacle, and wherein said heating element is on before substantially all water is pumped and off after substantially all water is pumped.

19. The combined infant formula warmer according to claim 18 wherein a pump actuator is connected to said pump, the actuator biased to a closed position but which may be moved to an open position when said receptacle is nested within said opening.

20. The combined infant formula warmer according to claim further comprising tubing to connect said water reservoir to a position above said receptacle, and wherein said tubing and said water reservoir comprise non-plastic materials.
